(19) United States
(12) Patent Application Publication
(10) Pub. No.: US 2011/0188694 A1
(43) Pub. Date: Aug. 4, 2011

(54) VARIABLE DIRECTIONAL MICROPHONE ASSEMBLY AND METHOD OF MAKING THE MICROPHONE ASSEMBLY

(76) Inventors: Sang-Ho Lee, Bucheon (KR); Hyoung-Ho Kim, Incheon (KR)

(21) Appl. No.: 12/663,182

(22) PCT Filed: Aug. 29, 2008
(86) PCT No.: PCT/KR2008/005091

§ 371 Date: Dec. 4, 2009

(30) Foreign Application Priority Data
Jul. 11, 2008 (KR) 10-2008-0067714

(51) Int. Cl. H04R 1/02; H04R 31/00

(52) U.S. Cl. 381/356; 29/594

(57) ABSTRACT

A variable directional microphone assembly and method of manufacturing the same, which includes a printed circuit board including a connection terminal provided to a surface thereof, and a semiconductor integrated circuit device mounted to another surface thereof, a microphone body including a first mounting space for mounting the semiconductor integrated circuit device, two second mounting spaces, and a coil spring insertion hole, the first mounting space being provided to a surface of the microphone body, the second mounting spaces being provided to another surface of the microphone body, two microphone devices mounted to the second mounting spaces, the insertion hole allowing the microphone device to be in contact with the printed circuit board, a coil spring inserted into the coil spring insertion hole to electrically connect the microphone device to the printed circuit board, and a case including a sound hole in a bottom thereof.

### TECHNICAL FIELD

The present invention relates to a variable directional microphone, and more particularly, to a variable directional microphone assembly and a method of manufacturing the variable directional microphone assembly, which can achieve miniaturization by mounting microphone devices in a compact structure with a microphone body, and reduce maintenance costs by transmitting a signal through contact using a coil spring for convenient replacement of the microphone device.

### BACKGROUND ART

Microphones are generally classified into a non-directional (whole directions) microphone and a directional microphone according to directional characteristics. Such directional microphones are classified into a bi-directional microphone and a uni-directional microphone. The bi-directional microphone exhibits faithful reproduction characteristics for front and rear incident sounds, but exhibits reduction characteristics for a lateral incident sound. Thus, a polar pattern of the bi-directional microphone for a sound source describes a figure eight. Also, the bi-directional microphone has favorable near field characteristics, which is widely used for announcers in noisy stadiums. The uni-directional microphone maintains an output value in response to a wide front incident sound, but reduces an output value of a rear incident sound source, to improve a S/N ratio for a front sound source, which has a good articulation to be widely applied to voice-recognition equipment.

While the directional microphones obtain directional characteristics by respectively forming sound holes in a case and a PCB surface and using a phase difference between a front sound and a rear sound through a single microphone, variable directional microphones, having variable directional characteristics through two non-directional microphones, have been developed.

In manufacturing a variable directional microphone assembly with two non-directional microphones, according to a related art, two non-directional microphone devices and a semiconductor integrated circuit device are directly mounted to a printed circuit board, so that a substrate itself must be replaced in maintenance for repairing defects of the microphone devices. Thus, costs are increased. Also, mechanical configuration for supplementing sound characteristics is unsatisfactory. Thus, sound quality is poor, and miniaturization is difficult.

### DISCLOSURE

### Technical Problem

The present invention has been made in an effort to solve the above-described limitations of the related art. An object of the present invention is to provide a variable directional microphone assembly and a method of manufacturing the same, which can replace microphone devices to reduce maintenance costs and can achieve miniaturization and improve sound quality, by disposing the microphone devices and a semiconductor integrated circuit device in a compact structure with a microphone body and by connecting a signal of a microphone through a coil spring.

### Technical Solution

To achieve these objects and other advantages and in accordance with the purpose of the invention, as embodied and broadly described herein, there is provided a variable directional microphone assembly including: a printed circuit board including a connection terminal provided to a surface thereof, and a semiconductor integrated circuit device mounted to another surface thereof; a microphone body including a first mounting space for mounting the semiconductor integrated circuit device, two second mounting spaces, and a coil spring insertion hole, the first mounting space being provided to a surface of the microphone body, the second mounting spaces being provided to another surface of the microphone body; two microphone devices mounted to the second mounting spaces, the insertion hole allowing the microphone device to be in contact with the printed circuit board; a coil spring inserted into the coil spring insertion hole to electrically connect the microphone device to the printed circuit board; and a case including a sound hole in a bottom thereof and configured to fix an assembly by inserting the microphone body coupled with the microphone devices and the semiconductor integrated circuit device into the case and then curling the case.

According to another aspect of the present invention, there is provided a method of manufacturing a variable directional microphone assembly, the method including: preparing a printed circuit board (PCB) by mounting a semiconductor integrated circuit device to the PCB using a surface mounting technology (SMT) and by cutting a bridge; preparing a microphone body; inserting a coil spring into a coil spring insertion hole of the microphone body; mounting a microphone device to amounting space of the microphone body and attaching a cushion; and inserting the semiconductor integrated circuit device of the loaded PCB into a mounting space of the microphone body to couple the PCB to the microphone body, and then inserting the PCB coupled to the microphone body into a loaded case, and curling the case.

### Advantageous Effects

In the microphone assembly according to the present invention, the microphone devices and the semiconductor integrated circuit device are disposed in a compact structure with the microphone body, and signals of the microphones are connected through the coil springs to allow the microphone devices to be replaced, thereby reducing maintenance costs, achieving miniaturization, and improving sound quality.

### DESCRIPTION OF DRAWINGS

FIG. 1 is an exploded perspective view illustrating a top side of a variable directional microphone assembly according to an embodiment of the present invention.

FIG. 2 is an exploded perspective view illustrating a bottom side of a variable directional microphone assembly according to an embodiment of the present invention.

FIG. 3 is a flowchart illustrating a method of manufacturing a variable directional microphone assembly according to an embodiment of the present invention.

FIGS. 4 through 8 are views illustrating a manufacturing process according to an embodiment of the present invention.

FIG. 9 is a cut-away perspective view illustrating a variable directional microphone according to an embodiment of the present invention.

FIG. 10 is a cross-sectional view illustrating a variable directional microphone according to an embodiment of the present invention.

### DESCRIPTION OF THE SYMBOLS IN MAIN PORTIONS OF THE DRAWINGS

100: VARIABLE DIRECTIONAL MICROPHONE ASSEMBLY

110: PRINTED CIRCUIT BOARD

120: MICROPHONE BODY 122-1, 122-2: MOUNTING SPACE FOR MICROPHONE

124: MOUNTING SPACE FOR SEMICONDUCTOR DEVICE

126: COIL SPRING INSERTION HOLE

128: COIL SPRING 130-1, 130-2: MICROPHONE DEVICE

132-1, 132-2: CUSHION 140: CASE

142-1, 142-2: SOUND HOLE 150: DUST-PREVENTION FABRIC

160: SEMICONDUCTOR INTEGRATED CIRCUIT DEVICE

### BEST MODE

Preferred embodiments of the present invention will be described below in more detail with reference to the accompanying drawings. The present invention may, however, be embodied in different forms and should not be constructed as limited to the embodiments set forth herein.

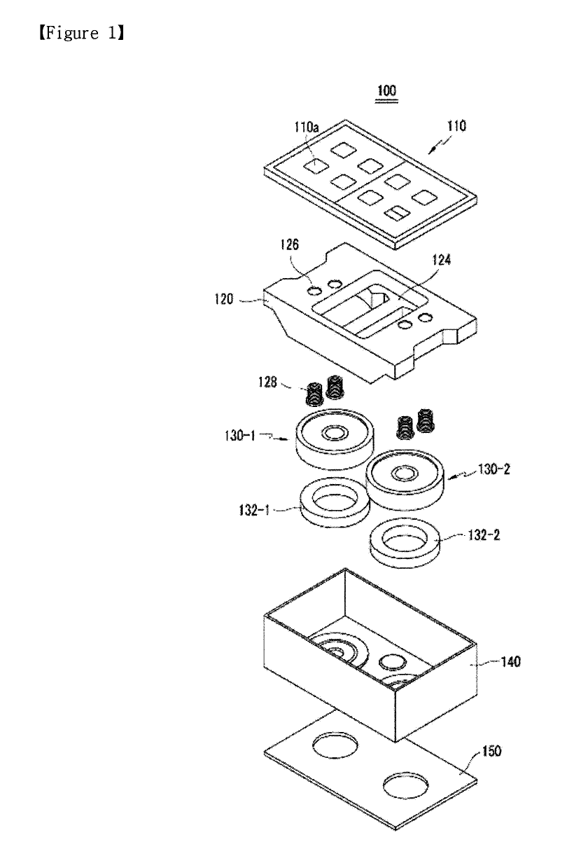

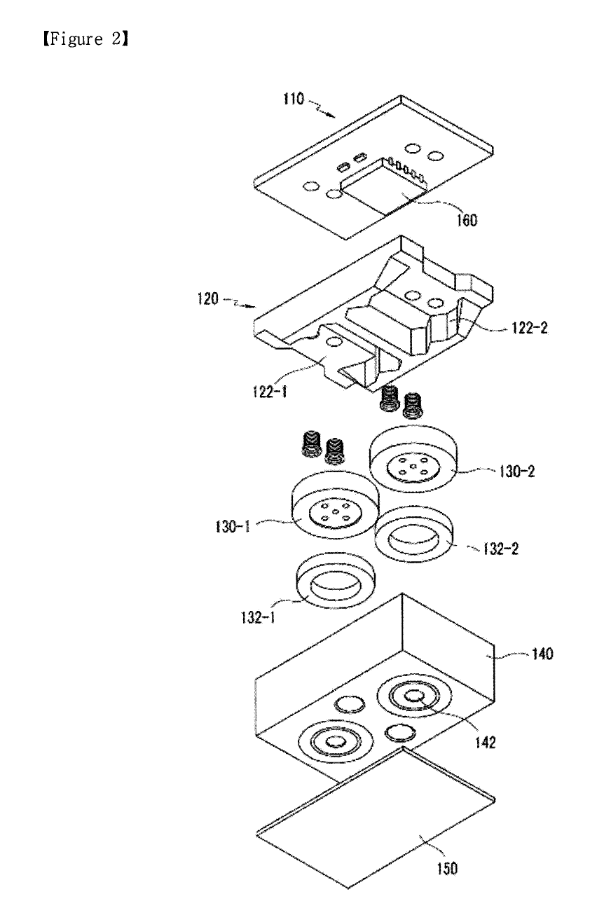

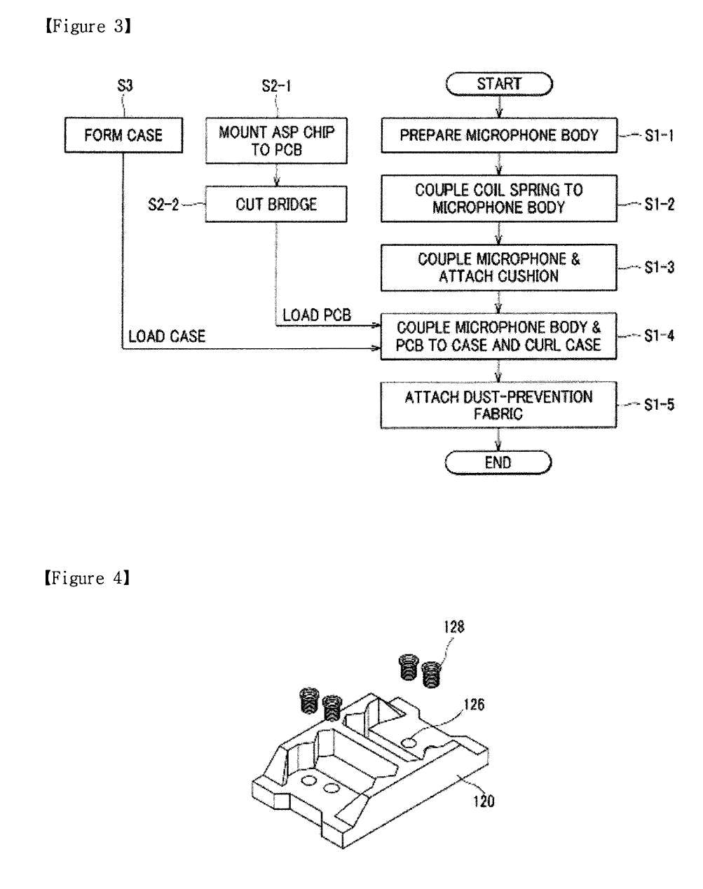

FIG. 1 is an exploded perspective view illustrating a top side of a variable directional microphone assembly 100 according to an embodiment of the present invention. FIG. 2 is an exploded perspective view illustrating a bottom side of the variable directional microphone assembly 100 according to the embodiment of the present invention. FIG. 3 is a flowchart illustrating a method of manufacturing the variable directional microphone assembly 100 according to the embodiment of the present invention.

Referring to FIGS. 1 and 2, the variable directional microphone assembly 100 includes a printed circuit board 110, a microphone body 120, first and second microphone devices 130-1 and 130-2, coil springs 128, cushions 132-1 and 132-2, a case 140, and a dust-prevention fabric 150. The printed circuit board 110 has one surface provided with connection terminals 110a, and another surface to which a semiconductor integrated circuit device 160 is mounted. A mounting space 124 for mounting the semiconductor integrated circuit device 160 is provided to one surface of the microphone body 120, and two mounting spaces 122-1 and 122-2 for mounting the microphone devices 130-1 and 130-2 are provided to another surface of the microphone body 120. The microphone body 120 includes coil spring insertion holes 126 allowing the microphone devices 130-1 and 130-2 mounted to the mounting spaces 122-1 and 122-2 to be in contact with the printed circuit board 110. The two microphone devices 130-1 and 130-2 are mounted to the mounting spaces 122-1 and 122-2. The coil springs 128 are inserted in the coil spring insertion hole 126 to electrically connect the microphone devices 130-1 and 130-2 to the printed circuit board 110. The cushions 132-1 and 132-2 are configured to protect the microphone devices 130-1 and 130-2. The case 140 is configured to fix an assembly by inserting the microphone body 120 coupled with the microphone devices 130-1 and 130-2 and the semiconductor integrated circuit device 160 and then performing a curling operation. The dust-prevention fabric 150 is attached to an outer bottom of the case 140.

Referring to FIGS. 1 and 2, one surface of the printed circuit board 110 is provided with the connection terminals 110a for connecting signals to the outside, and the semiconductor integrated circuit device 160 is mounted to another surface thereof. The semiconductor integrated circuit device 160 appropriately delays or integrates signals input from the two microphone devices 130-1 and 130-2 to generate a desired directional sound signal.

The microphone body 120 is an injection-molded part formed of polycarbonate (PC) or thermoplastic elastomer (TPE), and a center of one surface thereof is provided with the mounting space 124 for mounting the semiconductor integrated circuit device 160, and another surface thereof is provided with the mounting spaces 122-1 and 122-2 for mounting the microphone devices 130-1 and 130-2. Also, the coil spring insertion holes 126 are disposed in the microphone body 120 to allow the microphone devices 130-1 and 130-2 mounted to the mounting spaces 122-1 and 122-2 to be in contact with the printed circuit board 110. As such, according to the present invention, the microphone devices 130-1 and 130-2 are mechanically fixed through the microphone body 120 provided with the mounting spaces 122-1 and 122-2 for the microphone devices 130-1 and 130-2, thereby achieving a compact structure and obtaining favorable sound quality characteristics according to acoustic space. The case 140 has a rectangular container-shape with an open side, and a bottom thereof is provided with first and second sound holes 142-1 and 142-2 for introducing sound into the two microphone devices 130-1 and 130-2. After mounting parts including the microphone body 120 and the printed circuit board 110 to which the microphone devices 130-1 and 130-2 are mounted, ends 140a of the case 140 are curled to complete the assembly.

The first and second microphone devices 130-1 and 130-2, mounted to the mounting spaces 122-1 and 122-2 of the microphone body 120 are non-directional condenser microphones converting vibrations of an acoustic pressure introduced from the outside into electrical signals. The semiconductor integrated circuit device 160, mounted to the printed circuit board 110, is a digital signal processor (DSP) or an analog signal processor (ASP), which processes electrical sound signals transmitted from the first and second microphone devices 130-1 and 130-2 to generate variable directional electrical sound signals.

Referring to FIG. 3, the method of manufacturing the variable directional microphone assembly 100 will now be described. In operations S2-1 and S2-2, the semiconductor integrated circuit device 160 is mounted to the printed circuit board 110 using a surface mounting technology (SMT), and a bridge is cut to prepare the printed circuit board 110. In operation S3, the case 140 is formed. In operation S1-1, the microphone body 120 is prepared. In operation S1-2, the coil springs 128 are inserted into the coil spring insertion holes 126 of the microphone body 120. In operation S1-3, the microphone devices 130-1 and 130-2 are mounted to the mounting spaces 122-1 and 122-2 of the microphone body 120 and the cushions 132-1 and 132-2 are attached. In operation S1-4, the semiconductor integrated circuit device 160 of the loaded printed circuit board 110 is inserted into the mounting space 124 of the microphone body 120 to couple the printed circuit board 110 to the microphone body 120, and then the printed circuit board 110 coupled to the microphone body 120 is inserted into the loaded case 140, and the case 140 is curled. In operation S1-5, the dust-prevention fabric 150, for preventing the ingress of dust and moisture, is attached to a surface including the sound holes 142-1 and 142-2 of the completely assembled case 140.

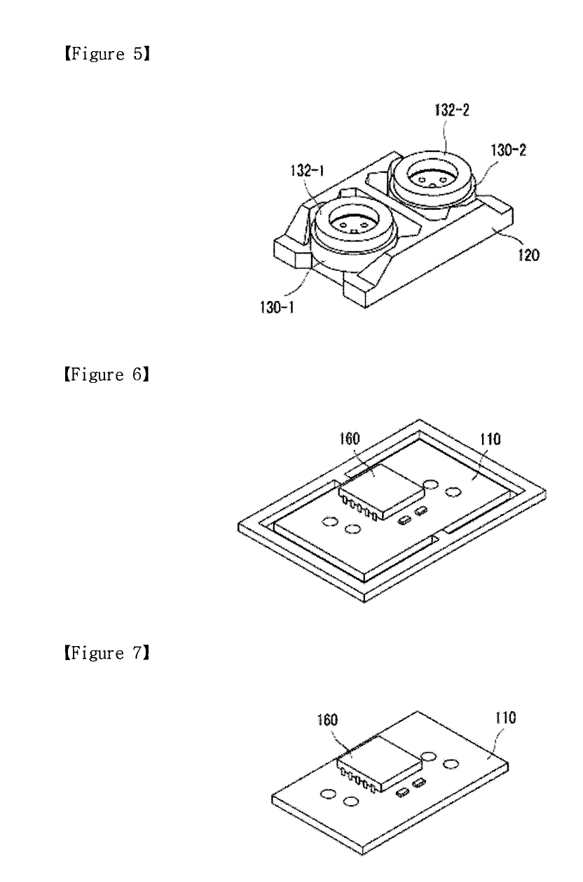

Referring to FIG. 3, in operation S1-1, the microphone body 120 is prepared. In operation S1-2, as illustrated in FIG. 4, the coil springs 128 are inserted into the coil spring insertion holes 126 of the microphone body 120. In operation S1-3, as illustrated in FIG. 5, the microphone devices 130-1 and 130-2 are mounted to the mounting spaces 122-1 and 122-2 of the microphone body 120, and then the cushions 132-1 and 132-2 are attached to the microphone devices 130-1 and 130-2 with an adhesive.

Meanwhile, in operation S2-1, as illustrated in FIG. 6, the semiconductor integrated circuit device 160 is mounted to the printed circuit board 110 with the surface mounting technology. Then, in operation S2-2, as illustrated in FIG. 7, the bridge is cut to prepare the printed circuit board 110 including the mounted semiconductor integrated circuit device 160. In operation S3, the case 140 is formed and prepared.

Then, in operation S1-4, as illustrated in FIG. 8, the microphone body 120 and the printed circuit board 110 are inserted into the case 140, and then the ends 140a are curled to complete the assembling. Then, in operation S1-5, the dust-prevention fabric 150, for preventing dust from being introduced into the microphone through the sound holes 142-1 and 142-2, is attached to the outer bottom of the assembled case 140.

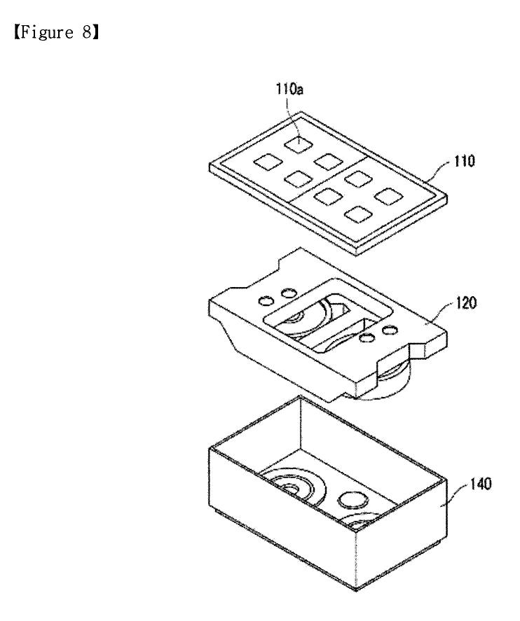

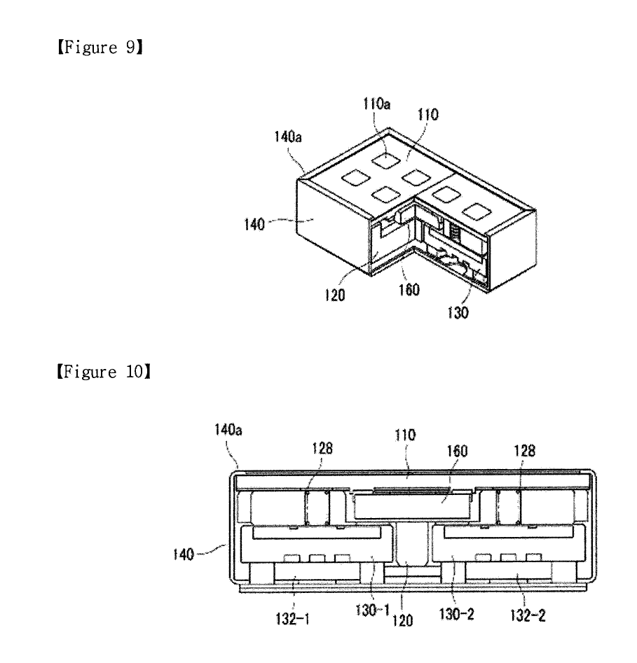

FIG. 9 is a cut-away perspective view illustrating the variable directional microphone according to the embodiment of the present invention. FIG. 10 is a cross-sectional view illustrating the variable directional microphone according to the embodiment of the present invention.

Referring to FIGS. 9 and 10, in the variable directional microphone assembly 100, the semiconductor integrated circuit device 160 is mounted to an inner side of the rectangular plate-shaped printed circuit board 110, and the semiconductor integrated circuit device 160 is inserted into the mounting space 124 of the microphone body 120, and the microphone devices 130-1 and 130-2 are respectively mounted to the mounting spaces 122-1 and 122-2 of the microphone body 120 to electrically connect to the printed circuit board 110 through the coil springs 128.

Also, the cushions 132-1 and 132-2, disposed between the microphone devices 130-1 and 130-2 and the case 140, serve as a buffer for them, and the dust-prevention fabric 150 is attached to the outer side of the case 140 to prevent a foreign object from being introduced into the microphone through the sound holes 142-1 and 142-2 of the case 140.

The variable directional microphone assembly 100 of the present invention is electrically connected to an electronic product (not shown) through the connection terminals 110a disposed on the outer side of the printed circuit board 110. Thus, when power is supplied to the variable directional microphone assembly 100, the first microphone device 130-1 receives sound through the first sound hole 142-1 disposed in the case 140 to generate an electrical sound signal and transmit the generated signal to the semiconductor integrated circuit device 160 mounted to the printed circuit board 110, through the coil springs 128, and the second microphone device 130-2 also receives sound through the second sound hole 142-2 disposed in the case 140 to generate an electrical sound signal and transmit the generated signal to the semiconductor integrated circuit device 160 mounted to the printed circuit board 110, through the coil springs 128. The semiconductor integrated circuit device 160 processes the electrical sound signals transmitted from the first and second microphone devices 130-1 and 130-2 to generate variable directional electrical sound signals and transmit the variable directional electrical sound signals through the connection terminals 110a to the electronic

1. A variable directional microphone assembly comprising:
a printed circuit board including a connection terminal provided to a surface thereof, and a semiconductor integrated circuit device mounted to another surface thereof;
a microphone body including a first mounting space for mounting the semi-conductor integrated circuit device, two second mounting spaces, and an insertion hole, the first mounting space being provided to a surface of the microphone body, the second mounting spaces being provided to another surface of the microphone body;
two microphone devices mounted to the second mounting spaces, the insertion hole allowing the microphone device to be in contact with the printed circuit board;
a conductive member inserted into the insertion hole to electrically connect the microphone device to the printed circuit board; and
a case including a sound hole in a bottom thereof and configured to fix an assembly by inserting the microphone body coupled with the microphone devices and the semiconductor integrated circuit device into the case and then curling the case.

2. The variable directional microphone assembly of claim 1, further comprising cushions respectively attached to the microphone devices, and a dust-prevention fabric attached to an outer surface of the case including the sound hole.

3. The variable directional microphone assembly of claim 2, wherein the microphone body comprises an injection-molded part formed of one of poly-carbonate (PC) and thermoplastic elastomer (TPE), and the semiconductor integrated circuit device comprises one of a digital signal processor (DSP) and an analog signal processor (ASP), and the conductive member comprises a coil spring.

4. A method of manufacturing a variable directional microphone assembly, the method comprising:
preparing a printed circuit board (PCB) by mounting a semiconductor integrated circuit device to the PCB using a surface mounting technology (SMT) and by cutting a bridge;
preparing a microphone body;
inserting a conductive member into an insertion hole of the microphone body;
mounting a microphone device to a mounting space of the microphone body and attaching a cushion; and
inserting the semiconductor integrated circuit device of the loaded PCB into a mounting space of the microphone body to couple the PCB to the microphone body, and then inserting the PCB coupled to the microphone body into a loaded case, and curling the case.

5. The method of claim 4, further comprising attaching a dust-prevention fabric, for preventing ingress of dust and moisture, to a surface including a sound hole of the curled case.
